(19) United States
(12) Patent Application Publication
(10) Pub. No.: US 2020/0100341 A1
(43) Pub. Date: Mar. 26, 2020

(54) High Color Quality White Light

(71) Applicant: Eaton Intelligent Power Limited, Dublin (IE)

(72) Inventors: Raymond George Janik, Fayetteville, GA (US); Christopher Lee Bohler, Peachtree City, GA (US)

(21) Appl. No.: 16/577,999

(22) Filed: Sep. 20, 2019

Related U.S. Application Data
(60) Provisional application No. 62/734,112, filed on Sep. 20, 2018.

(51) Int. Cl. H05B 33/08

(52) U.S. Cl. CPC H05B 33/0863

(57) ABSTRACT

A lighting device includes a light source that emits an illumination light, where the light source includes first one or more of LEDs to emit a green light, second one or more of LEDs to emit an amber light, third one or more of LEDs to emit a red light, and fourth one or more of LEDs to emit a deep red light. The illumination light includes at least the green light, the amber light, the red light, and the deep red light. The lighting device further includes a controller configured to control a current provided to the light source.

### CROSS REFERENCE TO RELATED APPLICATIONS

The present application claims priority under 35 U.S.C. Section 119(e) to U.S. Provisional Patent Application No. 62/734,112, filed Sep. 20, 2018 and titled “High Color Quality White Light,” the entire content of which is incorporated herein by reference.

### TECHNICAL FIELD

The present disclosure relates generally to lighting solutions, and more particularly to generating lights that have spectral distributions that closely match an incandescent light.

### BACKGROUND

A typical lighting fixture may have light emitting diodes (LEDs) designed to emit a light that has a particular Correlated Color Temperature (CCT). For example, an LED light fixture may emit a warm white light (e.g., 3000 K), a cool white light (e.g., 6000 K) or a light with a CCT between warm and cool white lights. In some cases, a light fixture may be tuned to emit a light with a desired CCT. For example, white color tuning is commonly accomplished by using a combination of warm white light and cool white light, resulting in a combined light with a combined CCT that is a combination of the CCT of the warm white light and the CCT of the cool white light. However, a white light emitted by typical (phosphor converted) white LEDs does not cover the full visible spectrum and generally results in a relatively high peak blue component at 450 nm and very low peaks at 470 nm to 500 nm. Thus, a solution that provides a light of a specific color temperature that has a relatively even spectral distribution and is close to the spectrum distribution of natural incandescent white light with high color quality may be desirable.

### SUMMARY

The present disclosure relates generally to lighting solutions, and more particularly to generating lights that have spectral distributions that closely match an incandescent light. In an example embodiment, a lighting device includes a light source that emits an illumination light, where the light source includes first one or more of LEDs to emit a green light, second one or more of LEDs to emit an amber light, third one or more of LEDs to emit a red light, and fourth one or more of LEDs to emit a deep red light. The illumination light includes at least the green light, the amber light, the red light, and the deep red light. The lighting device further includes a controller configured to control a current provided to the light source.

In another example embodiment, a lighting device includes a light source that emits an illumination light. The light source includes first one or more of LEDs to emit a first light having a first wavelength in a first range of 545 nanometer (nm)-555 nm, second one or more of LEDs to emit a second light having a second wavelength in a second range of 600 nm-610 nm, third one or more of LEDs to emit a third light having a third wavelength in a third range of 645 nm-655 nm, and fourth one or more of LEDs to emit a fourth light having a fourth wavelength in a fourth range of 660 nm-670 nm. The illumination light includes at least the first light, the second light, the third light, and the fourth light. The lighting device further includes a controller configured to control a current provided to the light source.

In another example embodiment, a lighting device includes a light source that emits an illumination light. The light source includes a first group of light emitting diodes (LEDs) to emit a warm white light, a second group of LEDs to emit a cool white light, a third group of LEDs to emit a deep incandescent white light having a correlated color temperature below 2000K. The illumination light includes one or more of the warm white light, the cool white light and the deep incandescent white light. The lighting device further includes a controller configured to control a current provided to the light source. Each of the first group of LEDs, the second group of LEDs, and the third group of LEDs includes first one or more of LEDs to emit a green light, second one or more of LEDs to emit an amber light, third one or more of LEDs to emit a red light, and fourth one or more of LEDs to emit a deep red light. Each of the first group of LEDs and the second group of LEDs may also include fifth one or more of LEDs to emit a violet light, sixth one or more of LEDs to emit a royal blue light, seventh one or more of LEDs to emit a blue light, eighth one or more of LEDs to emit a cyan light, and ninth one or more of LEDs to emit a yellow light.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a lighting device that includes multiple LED groups that produce different color lights according to an example embodiment;

FIG. 2 illustrates a graph showing relative contributions of different color lights produced by the LED groups of FIG. 1 to the white illumination light provided by the light source at different correlated color temperatures of the white illumination light according to an example embodiment;

FIG. 3A illustrates a spectral distribution of a white light produced by typical LEDs and a spectral distribution of an incandescent light at 3000K correlated color temperature (CCT) according to an example embodiment;

FIG. 3B illustrates a spectral distribution of the illumination light produced by the LED groups of FIG. 1 and a spectral distribution of an incandescent light at 3000K CCT according to an example embodiment;

FIG. 4A illustrates a spectral distribution of a white light produced by typical LEDs and a spectral distribution of an incandescent light at 5000K correlated color temperature (CCT) according to an example embodiment;

FIG. 4B illustrates a spectral distribution of the illumination light produced by the LED groups of FIG. 1 and a spectral distribution of an incandescent light at 5000K CCT according to an example embodiment;

FIG. 5 illustrates a lighting device that includes multiple LED groups that produce different color lights according to another example embodiment;

FIG. 6 illustrates a lighting device that includes multiple LED groups that produce different color lights according to another example embodiment;

FIG. 7 illustrates a lighting device that includes clustered LED groups that produce different color lights according to another example embodiment;

FIG. 8 illustrates a lighting device that includes a group of LEDs that produce different color lights according to another example embodiment;

FIG. 9 illustrates a lighting device that includes a group of LEDs that produce different color lights to enhance a light emitted by white LEDs according to an example embodiment; and

FIG. 10 illustrates a lighting device that includes multiple LED groups that each produce a light that has a respective CCT according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

In some example embodiments, a controller can steer a current between one or more strings of LEDs that consist of phosphor converted color LEDs and direct emission LEDs. The controller can steer the current such that the distribution of the produced light closely matches the distribution of an incandescent light for CCT ranges from 1000K to higher than 6000K.

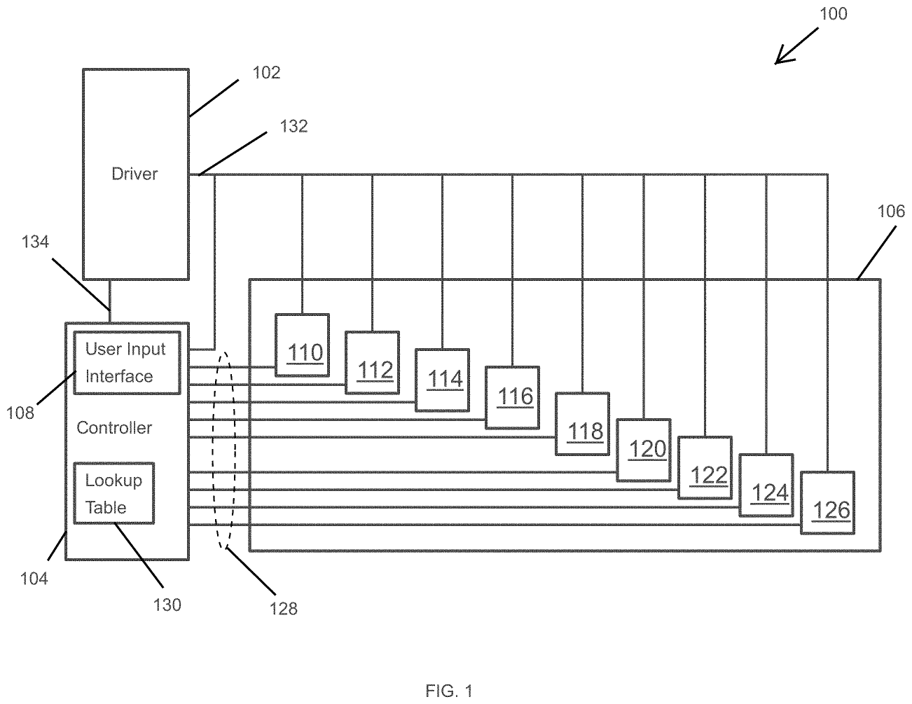

Turning now to the figures, particular example embodiments are described. FIG. 1 illustrates a lighting device 100 that includes multiple LED groups that produce different color lights according to an example embodiment. For example, the lighting device 100 may be a lighting fixture or included in a lighting fixture. In some example embodiments, the lighting device 100 includes a driver 102, a controller 104, and a light source 106. For example, the driver 102 may be a constant current driver and may provide a current to the light source 106 that provides a white illumination light. The controller 104 may control the current flow through the light source 106, for example, based on a user input provided to the controller 104 via a user input interface 108. For example, the user input interface 108 may include a potentiometer, a dip switch, or another component that allows a user to provide an input to the controller 104. Alternatively, or in addition, the user input interface 108 may include a receiver (e.g., a wireless or wired receiver or transceiver) that receives and provides a user input to the controller 104.

In some example embodiments, the user input interface 108 may wirelessly receive a lighting control command (e.g., a desired correlated color temperature) from a camera device and the controller 104 may control the current flow through the light source 106 based on the lighting control command, for example, such that the illumination light has a color temperature that closely matches the desired correlated color temperature. For example, when a camera device receives a user input to take a picture, the camera device may analyze the light that is received through the lens of the camera device to determine the lighting condition of the area and generate the lighting control command based on the lighting condition of the area. The camera device may take the picture in response to the user input after having transmitted the light control command to the light fixture so that the illumination light provided by the light source 106 is adjusted before the camera device takes the picture. The use of a camera device to control the lighting provided by lighting fixtures to improve the quality of pictures is described in more detail in U.S. patent application Ser. No. 15/617,504, which is incorporated herein by reference in its entirety.

In some example embodiments, the controller 104 may include analog and/or digital components to perform the operations described herein. To illustrate, the controller 104 may include a microcontroller, memory device, an analog-to-digital converter(s), a digital-to-analog converter(s), and other hardware and software components. For example, the controller 104 may include a microcontroller that executes software code stored in a memory device. The controller 104 may also include other active and passive components as can be understood by those of ordinary skill in the art with the benefit of this disclosure.

In some example embodiments, the light source 106 includes LED groups 110-126. For example, the LED group 110 may include one or more of LEDs that can emit a green (e.g., direct emission green or phosphor converted green) light. The LED group 112 may include one or more of LEDs that can emit an amber light. The LED group 114 may include one or more of LEDs that can emit a red light. The LED group 116 may include one or more of LEDs that can emit a deep red light. The LED group 118 may include one or more of LEDs that can emit a violet light. The LED group 120 may include one or more of LEDs that can emit a royal blue light. The LED group 122 may include one or more of LEDs that can emit a blue light. The LED group 124 may include one or more of LEDs that can emit a cyan light. The LED group 126 may include one or more of LEDs that can emit a yellow light. The one or more of LEDs may be discrete LEDs, organic light-emitting diodes (OLEDs), an LED chip on board that includes discrete LEDs, or an array of discrete LEDs, etc.

In some example embodiments, the driver 102 provides a current to the light source 106 via one or more electrical connections 132, and the controller 104 may control the amount of current that is provided to the light source 106 by the driver 102 via an electrical connection 132. To illustrate, the controller 104 may provide a control signal to the driver 102 via the electrical connection 134 to control the amount of current that the driver 102 provides to the light source 106. For example, the controller 104 may include a current sensor that senses the amount of the current provided by the driver 102 to the light source 106 on the connection 132 and may provide the control signal to the driver 102 based on the sensed current. The controller 104 may also generate the control signal provided via the connection 134 based on a user input provided to the controller 104 via the user input interface 108. For example, the user input may indicate or correspond to a desired correlated color temperature (e.g., 3000K) of the illumination light, a dim level of the illumination light, etc. In some example embodiments, the driver 102 or another power supply may provide power to the controller 104.

In some example embodiments, the controller 104 may control the amount of current that flows through each one of the LED groups 110-126. For example, the controller 104 may generate the control signals based on a user input provided to the controller 104 via the user input interface 108 and provide the control signals to the LED groups 110-126 via the connections 128. To illustrate, the user input provided to the controller 104 may indicate or correspond to a particular correlated color temperature of the illumination light provided by the light source 106 and/or to other characteristics (e.g., dim level) of the illumination light. Each LED group 110-126 may include a transistor (or another control device) that is, for example, in series with the one or more LEDs of each LED group 110-126, and the controller 104 may provide a respective one of the control signals 128 to the transistor of each LED group 110-126 to control the current flow through each LED group 110-126.

In some example embodiments, the controller 104 can control the distribution of the current provided by the driver 102 on the connection 132 among the LED groups 110-126 by controlling the current flow through each LED group 110-126. For example, the controller 104 may use the control signals 128 to fully turn on and off current flows through the LED groups 110-126. Alternatively or in addition, the controller 104 may use the control signals 128 to adjust the current flowing through each LED group 110-126 to various amounts, for example, by changing the resistance of the transistor in each LED group 110-126. By turning on and off and/or by adjusting current flows through one or more of the LED groups 110-126, the controller 104 can control the contribution of the light emitted by each LED group 110-126 to the illumination light provided by the light source 106.

In some example embodiments, the illumination light provided by the light source 106 is a combination of the green light provided by the LED group 110, the amber light provided by the LED group 112, the red light provided by the LED group 114, and the deep red light provided by the LED group 116. For example, using the respective control signals 128, the controller 104 may turn off current flows through the LED groups 118-126 such that the illumination light includes the green light, the amber light, the red light, and the deep red light but not the lights from the LED groups 118-126. The controller 104 may also adjust current flows through the LED groups 110-116 to appropriate amounts to produce a desired correlated color temperature of the illumination light. For example, the controller 104 may turn off the LED groups 118-126 and adjust current flows through the LED groups 110-116, if needed, based on a user input provided to the controller 104 indicating or corresponding to a desired correlated color temperature (e.g., 1600K) of the illumination light.

In some example embodiments, the illumination light provided by the light source 106 is a combination of all of the lights provided by the LED groups 110-126. To illustrate, the illumination light provided by the light source 106 is a combination of the green light provided by the LED group 110, the amber light provided by the LED group 112, the red light provided by the LED group 114, and the deep red light provided by the LED group 116, the violet light provided by the LED group 118, the royal blue light provided by the LED group 120, the blue light provided by the LED group 122, the cyan light provided by the LED group 124, and the yellow light provided by the LED group 126.

Table 1 below provides the wavelength at which each light emitted by the LED groups 118-126 has a peak intensity level and the range of wavelengths for each light emitted by the LED groups 118-126. For example, as shown in Table 1, the violet light emitted by the LED group 118 may have a peak intensity level at 420 nm wavelength and may be in a wavelength range of 400-430 nm. As another example, the blue light provided by the LED group 122 may have a peak intensity level at 475 nm wavelength and may be in a wavelength range of 470-480 nm. In some example embodiments, in Tables 1-8, the green light is a phosphor converted (PC) green light, the yellow light is a phosphor converted (PC) yellow light, the amber light is a phosphor converted (PC) amber light, the red light is a phosphor converted (PC) red light, and the deep red light is a phosphor converted (PC) deep red light. In some example embodiments, the other lights may be direct emission lights. In some alternative embodiments, one or more of the green light, the yellow light, the amber light, the red light, and the deep red light may be a direct emission light.

TABLE 1

| Light | Peak Wavelength | Wavelength Range |
|---|---|---|
| Violet | 420 | 400-430 |
| Royal Blue | 445 | 440-450 |
| Blue | 475 | 470-480 |
| Cyan | 500 | 495-505 |
| PC Green | 550 | 545-555 |
| PC Yellow | 570 | 565-575 |
| PC Amber | 605 | 600-610 |
| PC Red | 650 | 645-655 |
| PC Deep Red | 665 | 660-670 |

In some example embodiments, the controller 104 may control the current provided by the driver 102 to the light source 106 and the distribution of the current among the LED groups 110-126 based on a user input indicating or corresponding to a particular correlated color temperature of the illumination light and based on a lookup table 130 stored in the controller 104. For example, the lookup table 130 may be stored in a memory device of the controller 104. In some example embodiments, the information in the lookup table 130 may indicate the relationships between the lights emitted by the LED groups 110-126 to produce different correlated color temperature (CCT) values of the illumination light provided by the light source 106. For example, the information in Tables 2-8 below may be stored in the lookup table 130 and may be used by the controller 104 to adjust the CCT of the illumination light, for example, based on an input provided to the controller 104.

Table 2 below shows the relationships between the different lights emitted by the LED groups 110-126 such that the illumination light provided by the light source 106 has a CCT of 1600K. For example, the information in Table 2 may be stored in the lookup table 130 with respect to 1600K CCT. When a CCT setting input is provided to the controller 104 indicating or corresponding to 1600K, the controller 104 may use the information in Table 2 to control the LED groups 110-126 such that the illumination light has a CCT of 1600K.

To illustrate, to achieve the CCT of 1600K, the controller 104 may control the distribution of the current from the driver 102 among the individual LED groups 110-126 according to the values indicated in the “At Peak A” column of Table 2. The peak wavelength (A) for each light is provided above in Table 1.

For example, Table 2 can be interpreted as indicating that, to produce the illumination light with 1600K CCT, the violet light, the blue light, and the cyan light are off, the PC green light has 5 times the power of each of the royal blue light and the yellow light, the PC amber light has 8 times the power of each of the royal blue light and the yellow light, the PC red light has 31 times the power of each of the royal blue light and the yellow light, and the deep red light has 61 times the power of each of the royal blue light and the yellow light. The controller 104 may turn off current flows through the LED groups 118, 122, and 124, and adjust current flows through the remaining LED groups 110-116, 120, and 126 according to the relationships of the lights as shown in Table 2. In some example embodiments, the intensity levels of the lights at the peak wavelengths may be selected from the range of values in the range column of Table 2. For example, the intensity level of the yellow light at its peak wavelength may be zero or two instead of one shown in the “At Peak A” column of Table 2. As another example, the intensity level of the royal blue light at its peak wavelength may be zero or two instead of one shown in the “At Peak A” column of Table 2.

In some example embodiments, instead of intensity levels (or power), the values in Table 2 can be considered as amplitude of current flowing through the respective LED groups 110-126. For example, when the driver 102 provides individual currents (i.e., via separate connections) to the LED groups 110-126, the information in Table 2 may be considered as referring to the relationships between the currents provided to the LED groups 110-126 by the driver 102.

TABLE 2
1600 K

| | | |
|---|---|---|
| Light | At Peak λ | Range |

| | | | |
|---|---|---|---|
| Violet | 0 | 0 | 0 |
| Royal Blue | 1 | 0 | 2 |
| Blue | 0 | 0 | 0 |
| Cyan | 0 | 0 | 0 |
| PC Green | 5 | 3 | 7 |
| PC Yellow | 1 | 0 | 2 |
| PC Amber | 8 | 5 | 11 |
| PC Red | 31 | 27 | 43 |
| PC Deep Red | 61 | 46 | 79 |

Table 3 below shows the relationships between the different lights emitted by the LED groups 110-126 such that the illumination light has a correlated color temperature of 2700K. The information in Table 3 may be provide similar information and may be used in the same manner as described above with respect to Table 2. For example, the information in Table 3 may be stored in the lookup table 130 with respect to 2700K CCT. When a CCT setting input is provided to the controller 104 indicating or corresponding to 2700K, the controller 104 may use the information in Table 3 to control the LED groups 110-126 such that the illumination light has a CCT of 2700K.

TABLE 3
2700 K

| | | |
|---|---|---|
| Light | At Peak λ | Range |

| | | | |
|---|---|---|---|
| Violet | 3 | 0 | 5 |
| Royal Blue | 5 | 4.2 | 5.8 |
| Blue | 3 | 2 | 4 |
| Cyan | 2 | 0 | 4 |
| PC Green | 9 | 8.5 | 9.5 |
| PC Yellow | 2 | 1.5 | 2.5 |
| PC Amber | 3 | 1 | 5 |
| PC Red | 20 | 18 | 22 |
| PC Deep Red | 11 | 2 | 21 |

Table 4 below shows the relationships between the different lights emitted by the LED groups 110-126 such that the illumination light has a correlated color temperature of 3000K. The information in Table 4 may be provide similar information and may be used in the same manner as described above with respect to Table 2. For example, the information in Table 4 may be stored in the lookup table 130 with respect to 3000K CCT. When a CCT setting input is provided to the controller 104 indicating or corresponding to 3000K, the controller 104 may use the information in Table 4 to control the LED groups 110-126 such that the illumination light has a CCT of 3000K.

TABLE 4
3000 K

| | | |
|---|---|---|
| Light | At Peak λ | Range |

| | | | |
|---|---|---|---|
| Violet | 7 | 0 | 17 |
| Royal Blue | 6 | 5.3 | 6.7 |
| Blue | 3 | 2 | 4 |
| Cyan | 2 | 0.5 | 3.5 |
| PC Green | 9 | 8.5 | 9.5 |
| PC Yellow | 1 | 0.5 | 1.5 |
| PC Amber | 2 | 1 | 3 |
| PC Red | 16 | 15 | 17 |
| PC Deep Red | 4 | 1 | 7 |

Table 5 below shows the relationships between the different lights emitted by the LED groups 110-126 such that the illumination light has a correlated color temperature of 3500K. The information in Table 5 may be provide similar information and may be used in the same manner as described above with respect to Table 2. For example, the information in Table 5 may be stored in the lookup table 130 with respect to 3500K CCT. When a CCT setting input is provided to the controller 104 indicating or corresponding to 3500K, the controller 104 may use the information in Table 5 to control the LED groups 110-126 such that the illumination light has a CCT of 3500K.

TABLE 5
3500 K

| | | |
|---|---|---|
| Light | At Peak λ | Range |

| | | | |
|---|---|---|---|
| Violet | 9 | 0 | 2 |
| Royal Blue | 10 | 9 | 11 |
| Blue | 7 | 5.5 | 8.5 |
| Cyan | 3 | 2 | 4 |
| PC Green | 11 | 1.05 | 1.15 |
| PC Yellow | 2 | 1.15 | 2.5 |
| PC Amber | 2 | 1 | 3 |
| PC Red | 15 | 1.4 | 1.6 |
| PC Deep Red | 7 | 3 | 11 |

Table 6 below shows the relationships between the different lights emitted by the LED groups 110-126 such that the illumination light has a correlated color temperature of 4000K. The information in Table 6 may be provide similar information and may be used in the same manner as described above with respect to Table 2. For example, the information in Table 6 may be stored in the lookup table 130 with respect to 4000K CCT. When a CCT setting input is provided to the controller 104 indicating or corresponding to 4000K, the controller 104 may use the information in Table 6 to control the LED groups 110-126 such that the illumination light has a CCT of 4000K.

TABLE 6
4000 K

| | | |
|---|---|---|
| Light | At Peak λ | Range |

| | | | |
|---|---|---|---|
| Violet | 12 | 0 | 30 |
| Royal Blue | 16 | 15 | 17 |
| Blue | 11 | 9 | 13 |
| Cyan | 3 | 2 | 4 |
| PC Green | 16 | 15.5 | 16.5 |
| PC Yellow | 2 | 1.3 | 2.7 |
| PC Amber | 1 | 0 | 4 |
| PC Red | 19 | 18 | 20 |
| PC Deep Red | 6 | 0 | 13 |

Table 7 below shows the relationships between the different lights emitted by the LED groups 110-126 such that the illumination light has a correlated color temperature of 5000K. The information in Table 7 may be provide similar information and may be used in the same manner as described above with respect to Table 2. For example, the information in Table 7 may be stored in the lookup table 130 with respect to 5000K CCT. When a CCT setting input is provided to the controller 104 indicating or corresponding to 5000K, the controller 104 may use the information in Table 7 to control the LED groups 110-126 such that the illumination light has a CCT of 5000K.

TABLE 7
5000 K

| | | |
|---|---|---|
| Light | At Peak λ | Range |

| | | | |
|---|---|---|---|
| Violet | 20 | 0 | 40 |
| Royal Blue | 36 | 34 | 38 |
| Blue | 15 | 10 | 21 |
| Cyan | 10 | 8.5 | 11.5 |
| PC Green | 21 | 20.4 | 21.5 |
| PC Yellow | 3 | 2 | 4 |
| PC Amber | 1 | 0 | 3 |
| PC Red | 20 | 19 | 21 |
| PC Deep Red | 7 | 0 | 14 |

Table 8 below shows the relationships between the different lights emitted by the LED groups 110-126 such that the illumination light has a correlated color temperature of 6500K. The information in Table 8 may be provide similar information and may be used in the same manner as described above with respect to Table 2. For example, the information in Table 8 may be stored in the lookup table 130 with respect to 6500K CCT. When a CCT setting input is provided to the controller 104 indicating or corresponding to 6500K, the controller 104 may use the information in Table 8 to control the LED groups 110-126 such that the illumination light has a CCT of 6500K.

TABLE 8
6500 K

| | | |
|---|---|---|
| Light | At Peak λ | Range |

| | | | |
|---|---|---|---|
| Violet | 27 | 0 | 50 |
| Royal Blue | 88 | 84 | 82 |
| Blue | 21 | 12 | 28 |
| Cyan | 26 | 24 | 28 |
| PC Green | 35 | 34 | 36 |
| PC Yellow | 2 | 0 | 4 |
| PC Amber | 5 | 3 | 7 |
| PC Red | 23 | 22 | 24 |

By using the LED groups 110-126 that produce the color lights described herein, the lighting device 100 may provide the illumination light provided by the light source 106 such that the illumination light has a high color quality. By more evenly spreading intensity level of the illumination light at the lower wavelengths between 450 nm and 500 nm, the dominance of higher frequency colors, such as 450 nm blue, can be reduced, which can result in a spectral distribution that more closely matches that of an incandescent and provides a softer visual effect. Further, by using the LED groups 110-126 that produce the color lights described herein, the lighting device 100 may produce the illumination light with relatively low CCT while providing a high color quality and closely matching the spectral distribution of an incandescent light. For example, the controller 104 may control the LED groups 110-126 such that the CCT of the illumination light provided by the light source 106 can be lower than 1500K for deep dimming and architectural applications. The controller 104 can control the LED groups 110-126 to provide a light at allows a camera to capture high quality images even at low dimming levels.

In some alternative embodiments, the lighting device 100 may include more or fewer LED groups, other components, different configurations of components, etc. without departing from the scope of this disclosure. For example, some of the LED groups may be omitted if the lighting device 100 is intended to produce the illumination light at CCT values that do not need any or meaningful contribution from those LED groups. To illustrate, the LED groups 118-126 may be omitted if the illumination light is intended to have a CCT of 1600K.

In some alternative embodiments, a desired correlated color temperature of the illumination light may be provided to the controller by means other than or in addition to the user input interface 108. For example, the controller 104 may be configured to control the light source 106 based on information from a timer, a sensor (e.g., light sensor), etc. instead of or in addition to input received via the user input interface 108. In some example embodiments, information related to other CCT values instead of or in addition to the CCT values in the Tables 2-8 may be stored in the lookup table 130, and can be used to adjust the CCT of the illumination light. In some alternative embodiments, the lookup table 130 may be omitted, and the controller 104 may control the LED groups 110-126 for a single fixed CCT value or based on calculated information.

In some alternative embodiments, the lookup table 130 may be omitted, and the controller 104 may control the LED groups 110-126 for multiple CCT values based on hardwired information corresponding to different CCT values. In some alternative embodiments, the LED groups 110-126 may be configured in a different manner than shown in FIG. 1 without departing from the scope of this disclosure. In some alternative embodiments, the controller 104 may control the distribution of current to the LED groups 110-126 in a different manner than described herein without departing from the scope of this disclosure. In some alternative embodiments, the light source 106 may include one or more LEDs that produce one or more different color lights and/or a white light.

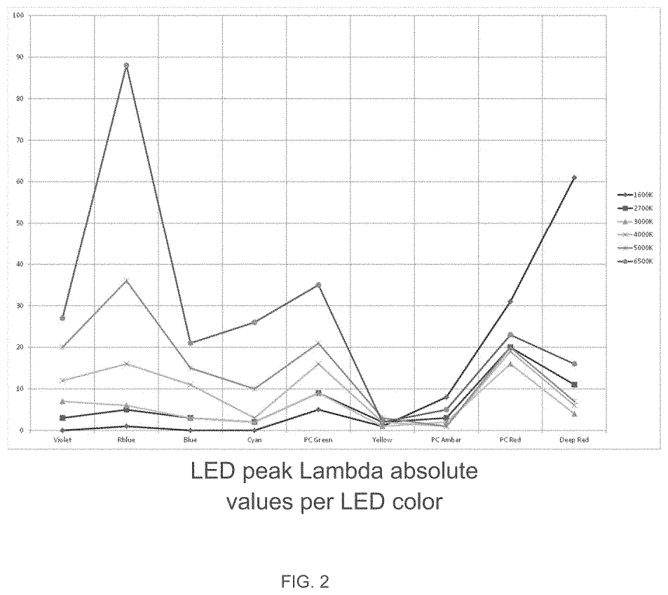

FIG. 2 illustrates a graph showing relative contributions of different color lights produced by the LED groups of FIG. 1 to the white illumination light provided by the light source 106 at different correlated color temperatures of the white illumination light according to an example embodiment. Referring to FIGS. 1 and 2, the numbers in the vertical axis of the graph unit-less numbers intended to show relative contributions of the different lights at various CCT values. For example, at 6500K CCT of the illumination light, the contribution of the royal blue light is significantly higher at approximately 88 than the contribution of, for example, the yellow light at approximately 3. The information in the graph can be used in similar manner as the information in the Tables 2-8 to control the distribution of current among the LED groups to produce the illumination light with the desired CCT.

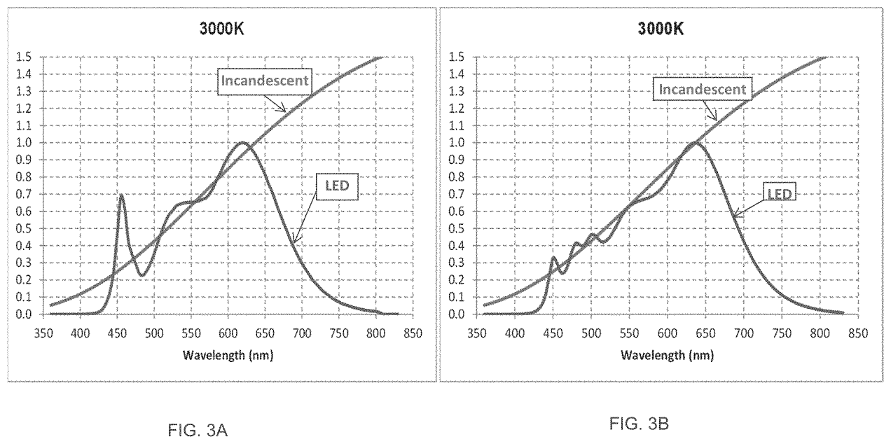

FIG. 3A illustrates a spectral distribution of a white light produced by typical LEDs and a spectral distribution of an incandescent light at 3000K correlated color temperature (CCT) according to an example embodiment. FIG. 3B illustrates a spectral distribution of the illumination light produced by the LED groups of FIG. 1 and a spectral distribution of an incandescent light at 3000K CCT according to an example embodiment. As can be seen by comparing the two graphs, the illumination light produced by the LED groups of FIG. 1 has a more even spectral distribution that more closely matches the spectral distribution of the incandescent light as compared to the spectral distribution of the white light produced by typical LEDs. For example, for the typical LED light of FIG. 3A, the CRI values are R9 of 81, Ra of 93, and the TM 30 values are Rf of 88 and Rg of 105. In contrast, for the illumination light provided by the light source 102 as shown in FIG. 3B, CRI values are R9 of 99, Ra of 97, and the TM 30 values are Rf of 94 and Rg of 99.

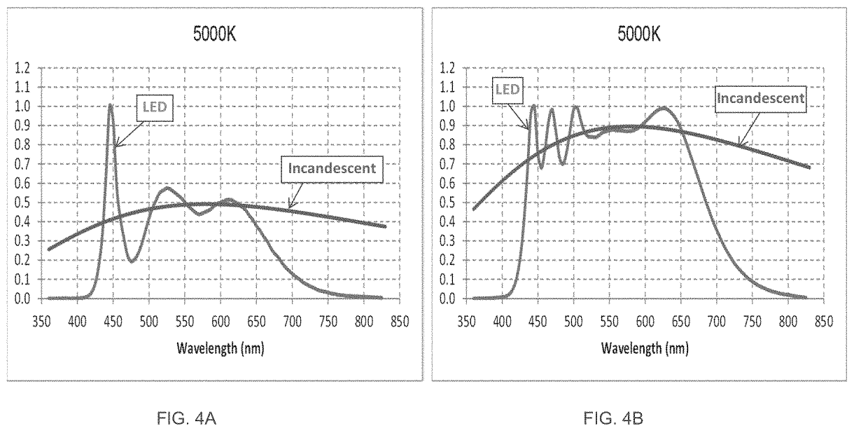

FIG. 4A illustrates a spectral distribution of a white light produced by typical LEDs and a spectral distribution of an incandescent light at 5000K correlated color temperature (CCT) according to an example embodiment. FIG. 4B illustrates a spectral distribution of the illumination light produced by the LED groups of FIG. 1 and a spectral distribution of an incandescent light at 5000K CCT according to an example embodiment. As can be seen by comparing the two graphs, the illumination light produced by the LED groups of FIG. 1 has a more even spectral distribution that more closely matches the spectral distribution of the incandescent light as compared to the spectral distribution of the white light produced by typical LEDs. For example, for the typical LED light of FIG. 4A, the CRI values are R9 of 77, Ra of 92, and the TM 30 values are Rf of 89 and Rg of 101. In contrast, for the illumination light provided by the light source 102 as shown in FIG. 4B, CRI values are R9 of 97, Ra of 97, and the TM 30 values are Rf of 94 and Rg of 101.

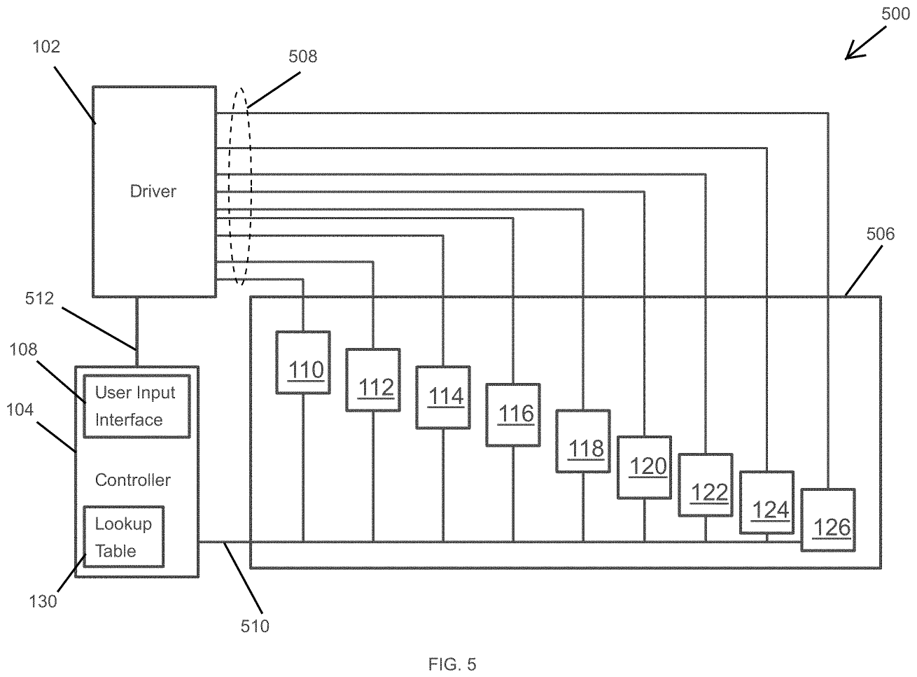

FIG. 5 illustrates a lighting device 500 that includes multiple LED groups that produce different color lights according to another example embodiment. In some example embodiments, the lighting device 500 includes the driver 102, the controller 104, and a light source 506. The light source 506 includes the LED groups 110-126 described above with respect to FIG. 1. In contrast to the lighting device 100 of FIG. 1, in FIG. 5, the driver 102 provides individual currents to the LED groups 110-126 via separate electrical connections 508.

In some example embodiments, the controller 104 operates in a similar manner as described above with respect to FIG. 1 to control the contributions of the different color lights from the LED groups 110-126 to the illumination light provided by the light source 506. In contrast to the lighting device 100 of FIG. 1, in FIG. 5, the controller 104 provides one or more control signals to the driver 102 via a connection 512 (e.g., one or more electrical wires) to control the individual currents provided by the driver 102 to the LED groups 110-126. The controller 104 may control the driver 102 based on an input (e.g., CCT setting input, dim level input, etc.) provided to the controller 104 and based on the information from the lookup table 130 with respect to CCT value associated contributions of the different color lights from the LED groups 110-126 in the same manner as described above with respect to FIG. 1. For example, the controller 104 may generate the one or more control signals to the driver 102 based on a user input provided to the controller 104 via the user input interface 108. The controller 104 may also control the driver 102 based on the total current provided to the light source 106 by the driver 102 as determined via a connection 510. In some example embodiments, the total current provided by the driver 102 may change, for example, based on a dim level setting provided to the driver 102. In contrast to the lighting device 100 of FIG. 1, in FIG. 5, the controller 104 does not provide individual control signals to the LED groups 110-126 to control current flows through the LED groups 110-126.

In some alternative embodiments, the lighting device 500 may include more or fewer LED groups, other components, different configurations of components, etc. without departing from the scope of this disclosure. For example, some of the LED groups may be omitted if the lighting device 500 is intended to produce the illumination light at CCT values that do not need any or meaningful contribution from those LED groups. To illustrate, the LED groups 118-126 may be omitted if the illumination light is intended to have a CCT of 1600K.

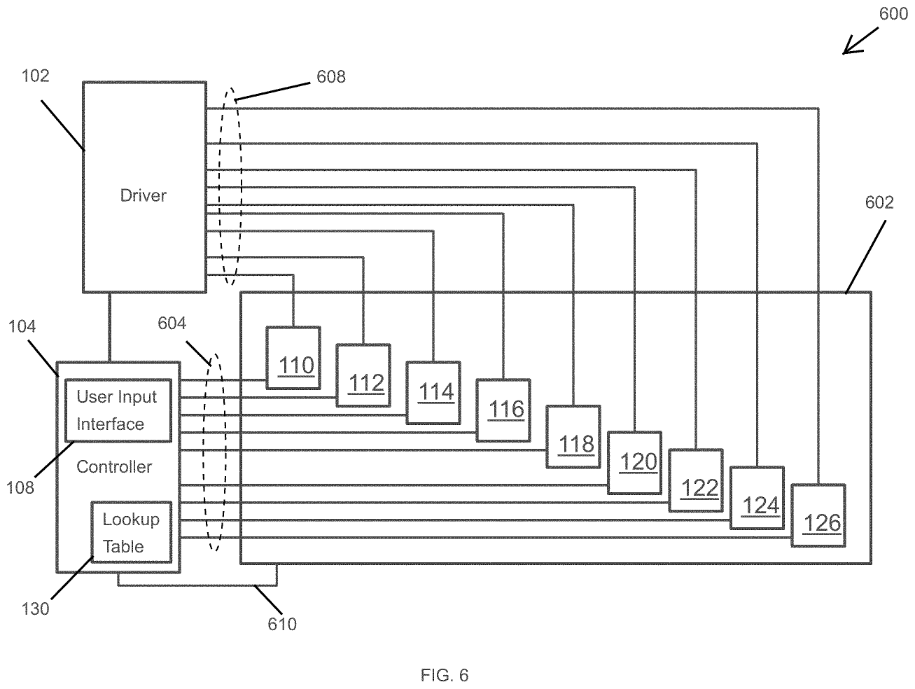

FIG. 6 illustrates a lighting device 600 that includes multiple LED groups that produce different color lights according to another example embodiment. In some example embodiments, the lighting device 600 includes the driver 102, the controller 104, and a light source 602. The light source 602 includes the LED groups 110-126 described above with respect to FIG. 1. In contrast to the lighting device 100 of FIG. 1, in FIG. 6, the driver 102 provides individual currents to the LED groups 110-126 via separate electrical connections 608 in a similar manner as described with respect to FIG. 5.

In some example embodiments, the controller 104 operates in a similar manner as described above with respect to FIG. 1 to control the contributions of the different color lights from the LED groups 110-126 to the illumination light provided by the light source 602. Similar to the lighting device 100, the controller 104 also provides control signals 604 to the LED groups 110-126 to control current flow through each one of the LED groups 110-126 individually. The controller 104 may control the current flows through the LED groups 110-126 based on an input (e.g., CCT setting input, dim level input, etc.) provided to the controller 104 and based on the information from the lookup table 130 with respect to CCT value associated contributions of the different color lights from the LED groups 110-126 in the same manner as described above with respect to FIG. 1. For example, the controller 104 may generate the control signals 604 based on a user input provided to the controller 104 via the user input interface 108. The controller 104 may also control the LED groups 110-126 based on the total current flowing through the light source 602 as determined via a connection 610. In some example embodiments, the total current flowing through the light source 602 may change, for example, based on a dim level setting provided to the driver 102.

In some alternative embodiments, the lighting device 600 may include more or fewer LED groups, other components, different configurations of components, etc. without departing from the scope of this disclosure. For example, some of the LED groups may be omitted if the lighting device 600 is intended to produce the illumination light at CCT values that do not need any or meaningful contribution from those LED groups. To illustrate, the LED groups 118-126 may be omitted if the illumination light is intended to have a CCT of 1600K.

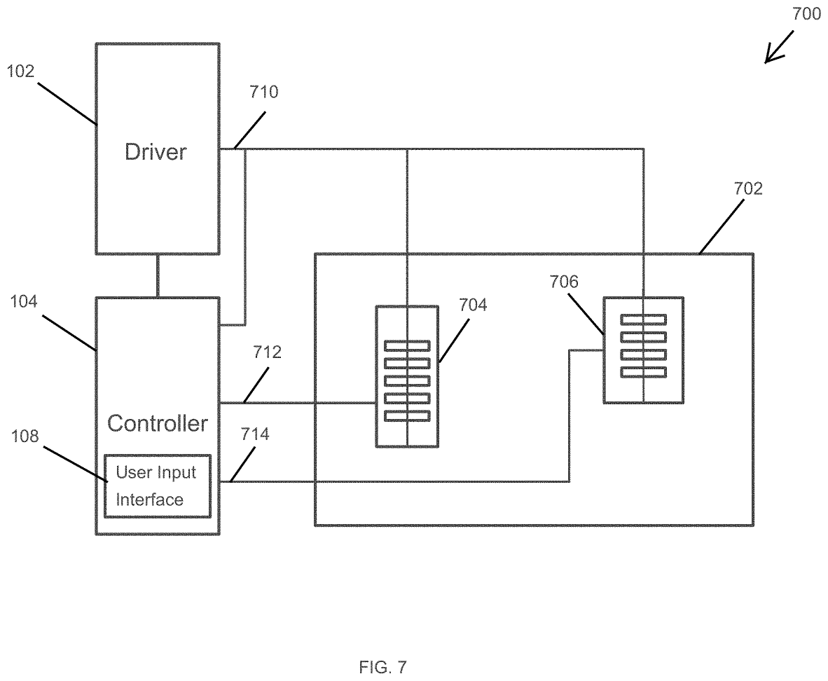

FIG. 7 illustrates a lighting device 700 that includes clustered LED groups that produce different color lights according to another example embodiment. In some example embodiments, the lighting device 700 includes the driver 102, the controller 104, and a light source 702. The driver 102 may provide a current to the light source 702 that can be distributed among the LED groups of the light source 702.

To illustrate, the light source 702 may include a first string of LEDs 704 and a second string of LEDs 706. The illumination light provided by the light source 702 may be a combination of the lights provided by string of LEDs 704, 706. The first string of LEDs 704 may include LEDs that emit five different color lights, and the second string of LEDs 706 may include LEDs that emit four different color lights. Alternatively, each string of LEDs 704, 706 may include LEDs that emit more or fewer number of color lights.

In some example embodiments, the same amount of current may flow through all of the LEDs in the first string of LEDs 704, and the same amount of current may flow through all of the LEDs in the second string of LEDs 706. Alternatively, the amount of current provided to each string of LEDs 704, 706 may be distributed unevenly among different LEDs of the particular string of LEDs 704, 706.

In some example embodiments, the intensity levels of the different color lights that are emitted by the LEDs of the strings of LEDs 704, 706 are related to each other in a manner that matches the relationships of the respective color lights in the relevant Table 2-8. For example, the first string of LEDs 704 may include one or more LEDs that emit a violet light, one or more LEDs that emit a royal blue light, one or more LEDs that emit a blue light, one or more LEDs that emit a cyan light, and one or more LEDs that emit a yellow light, and the second string of LEDs 706 may include one or more LEDs that emit a green light, one or more LEDs that emit an amber light, one or more LEDs that emit a blue light, one or more LEDs that emit a red light, and one or more LEDs that emit a deep red light.

The number of LEDs in the strings of LEDs 704, 706 that emit each respective color light may be such that the relationship or ratio of the intensity levels of the different color lights matches the relationship or ratio based on the information provided in the relevant one of the Tables 2-8. For example, for a CCT of 2700K, the relationship or ratio of the intensity levels of the different color lights emitted by the LEDs of the strings of LEDs 704, 706 matches the relationship or ratio of the numbers in the “At Peak A” column of Table 3 for the relevant color lights. As another example, for a CCT of 3000K, the relationship or ratio of the intensity levels of the different color lights emitted by the LEDs of the strings of LEDs 704, 706 matches the relationship or ratio of the numbers in the “At Peak A” column of Table 4 for the relevant color lights. In some example embodiments, for a particular CCT of the illumination light provided by the light source 702, the relationship or ratio of the numbers of LEDs in the strings of LEDs 704, 706 that emit the different color lights may match the relationship or ratio of the numbers in the “At Peak A” column of the relevant one of the Tables 2-8.

The controller 104 may control the current flow through each string of LEDs 704, 706 using control signals 712, 714. For example, the controller 104 may generate the control signals 712, 714 based on a user input provided to the controller 104 via the user input interface 108. The control signals 712, 714 may control current flows through the strings of LEDs 704, 706, for example, by controlling a respective transistor that is included in each string of LEDs 704, 706. The controller 104 may turn off, increase and decrease current flow through each string of LEDs 704, 706 using the control signals 712, 714. In some example embodiments, each control signal 712, 714 may include multiple signals that each control a respective transistor to that controls current through one or more LEDs of each string of LEDs 704, 706. The controller 104 may control current flows through the strings of LEDs 704, 706 such that the illumination light provided by the light source 702 has a desired CCT.

In some alternative embodiments, the lighting device 700 may include more or fewer strings of LEDs. For example, the LEDs of the strings of LEDs 704, 706 may be grouped differently.

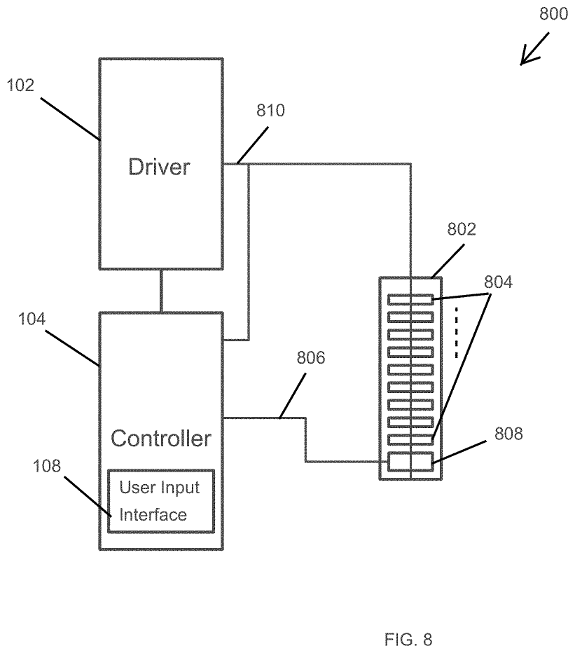

FIG. 8 illustrates a lighting device 800 that includes a group of LEDs that produce different color lights according to another example embodiment. In some example embodiments, the lighting device 800 includes the driver 102, the controller 104, and a light source 802. The light source 802 may include LEDs 804 that emit different color lights. The driver 102 may provide a current to the light source 802, and the controller 104 may control the flow of the current through the LEDs 804 using a control signal 806 provided to, for example, a transistor 808.

In some example embodiments, the LEDs 804 include LEDs that emit nine color lights listed in Table 1. The number of LEDs in the light source 802 that emit each respective color light may be such that the relationship or ratio of the intensity levels of the different color lights matches the relationship or ratio of the numbers in the “At Peak A” column of the relevant one of the Tables 2-8.

In some example embodiments, the LEDs 804 include LEDs that emit fewer color lights than the nine color lights depending on the particular CCT of illumination light provided by the light source 802. For example, the LEDs 804 may include LEDs that emit a green light, a PC amber light, a PC red light, and a deep red light when the lighting device 800 is intended to provide an illumination light that a 1600K CCT. For 1600K CCT illumination light, the number of LEDs in the light source 802 that emit each of the four color lights may be such that the relationship or ratio of the intensity levels of the different color lights matches the relationship or ratio of the numbers in the “At Peak A” column of Table 3 for the relevant color lights.

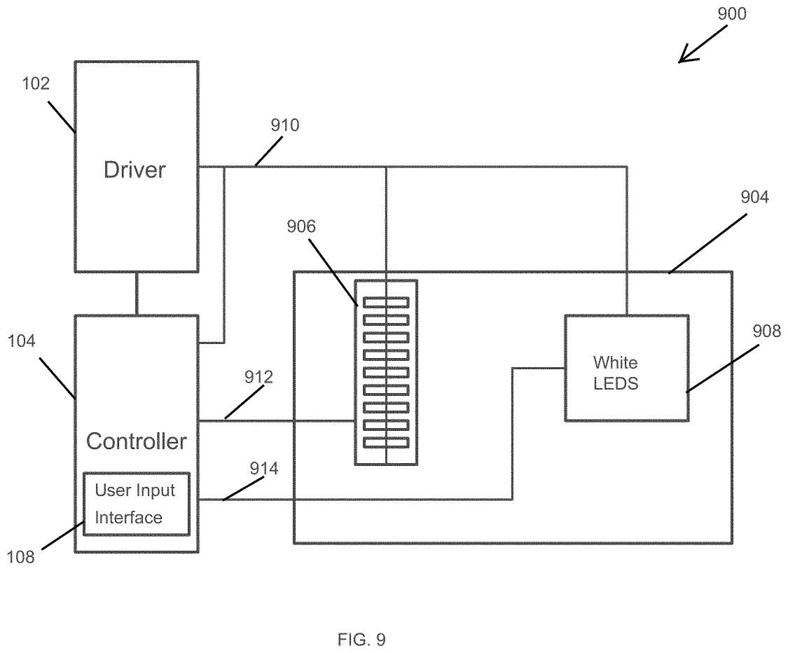

FIG. 9 illustrates a lighting device 900 that includes a group of LEDs that produce different color lights to enhance a light emitted by white LEDs according to an example embodiment. In some example embodiments, the lighting device 900 includes the driver 102, the controller 104, and a light source 904. The light source 904 may include a string of LEDs 906 that emit different color lights and white LEDs 908 that emit a typical white light. For example, the white LEDs 908 may be phosphor converted white LEDs. The illumination light provided by the light source 904 may include the different color lights provided by the string of LEDs 906 and the white light from the white LEDs.

In some example embodiments, the string of LEDs 906 may correspond to the light source 802 shown in FIG. 8 and may provide different color lights as described above. For example, the numbers of LEDs in the string of LEDs 906 may match the different numbers of LEDs in the light source 802. The driver 102 may provide a current to the light source 904, and the controller 104 may control the flows of the current through the LEDs 904 and the white LEDs 908 using control signals 912, 914.

In some example embodiments, the different color lights provided by the string of LEDs 906 may enhance the color quality of the white light emitted by the white LEDs 908 and result in the illumination light provided by the light source 904 having a higher color quality.

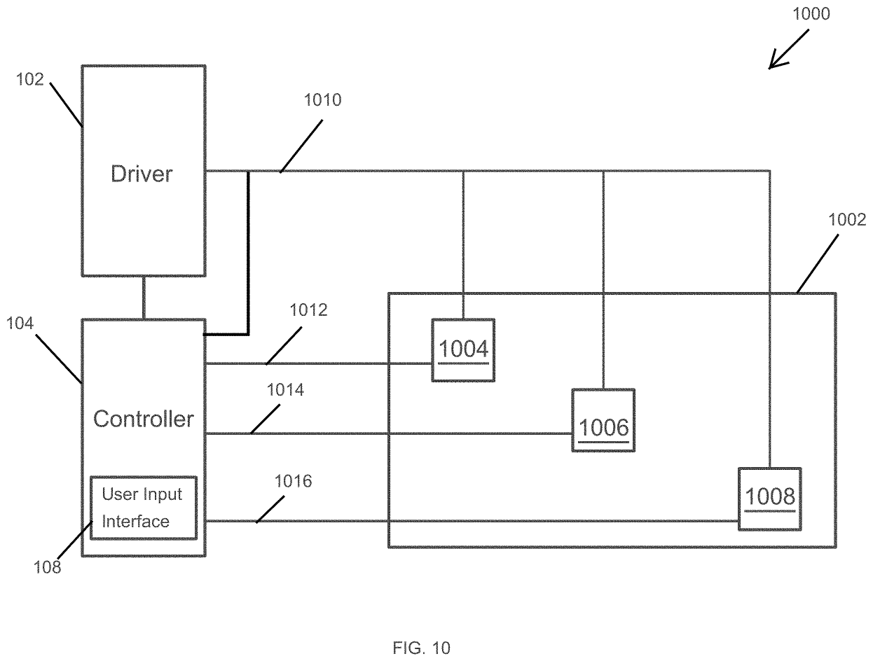

FIG. 10 illustrates a lighting device 1000 that includes multiple LED groups that each produce a light that has a respective CCT according to another example embodiment. In some example embodiments, the lighting device 1000 includes the driver 102, the controller 104, and a light source 1002. The light source 1002 may include LED groups 1004, 1006, 1008 that emit a light having a respective CCT. The illumination light provided by the light source 1002 may include one or more of the lights provided by the s LED groups 1004, 1006, 1008.

In some example embodiments, each LED group 1004, 1006, 1008 may correspond to the light source 106, 506, 602, 702, 802, or 902. For example, the LED group 1004 may be configured to emit a light having a CCT in the range of 2700K-3000K, where the light is produced from different color lights listed in Table 1. The LED group 1006 may be configured to emit a light having a CCT in the range of 5000K-6500K, where the light is produced from different color lights listed in Table 1. The LED group 1008 may be configured to emit a light having a CCT in the range of 1000K-1800K, where the light is produced from some or all of the different color lights listed in Table 1. Each LED group 1004, 1006, 1008 may be configured to provide the respective light with a fixed CCT in the respective ranges in a manner described above.

In some example embodiments, the driver 102 provides a current to the light source 1002 via a connection 1010, and the controller 104 may steer the current by controlling the individual LED groups 1004, 1006, 1008 using control signals provided to the LED groups 1004, 1006, 1008 via connections 1012, 1014, 1016. For example, each LED group 1004, 1006, 1008 may include a transistor that is controlled by the respective control signal from the controller 104 to steer the current provided by the driver 102 among the LED groups 1004, 1006, 1008. For example, by turning off current flow through the LED groups 1004 and 1006, the light source 1002 may produce the illumination light with a CCT matches the deep incandescent CCT of the light provided by the LED group 1008. As another example, by turning off current flow through the LED groups 1004 and 1008, the light source 1002 may produce the illumination light with a CCT that matches the cool CCT of the light provided by the LED group 1006. As another example, by turning off current flow through the LED groups 1006 and 1008, the light source 1002 may produce the illumination light with a CCT that matches the warm CCT of the light provided by the LED group 1004. By providing current among two of the three LED groups 1004, 1006, 1008, the light source 1002 may produce the illumination light with a CCT that is between the CCTs of the lights emitted by the two LED groups. The controller 104 may control current flow through the LED groups 1004, 1006, 1008 based on input (e.g., CCT setting input, dim level input, etc.) provided to the controller 104 and/or the driver 102. For example, the controller 104 may generate the control signals provided to the LED groups 1004, 1006, 1008 via the connections 1012, 1014, 1016 based on a user input provided to the controller 104 via the user input interface 108.

In some alternative embodiments, the lighting device 1002 may include other LED groups that are similar to the LED groups 1004, 1006, 1008 without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A lighting device, comprising:
a light source that emits an illumination light, wherein the light source comprises:
first one or more of LEDs to emit a green light;
second one or more of LEDs to emit an amber light;
third one or more of LEDs to emit a red light; and
fourth one or more of LEDs to emit a deep red light, wherein the illumination light includes at least the green light, the amber light, the red light, and the deep red light; and
a controller configured to control a current provided to the light source.

2. The lighting device of claim 1, wherein the light source further comprises:
fifth one or more of LEDs to emit a violet light;
sixth one or more of LEDs to emit a royal blue light;
seventh one or more of LEDs to emit a blue light;
eighth one or more of LEDs to emit a cyan light; and
ninth one or more of LEDs to emit a yellow light, wherein the illumination light further includes the violet light, royal blue light, the blue light, the cyan light, and the yellow light.

3. The lighting device of claim 2, wherein the green light is a phosphor converted green light, wherein the amber light is a phosphor converted amber light, and wherein the red light is a phosphor converted red light.

4. The lighting device of claim 2, wherein the controller is configured to control the current based on a correlated color temperature setting input corresponding to a desired correlated color temperature of the illumination light.

5. The lighting device of claim 2, wherein the controller is configured to control a distribution of the current to the first, the second, the third, the fourth, the fifth, the sixth, the seventh, the eighth, and the ninth one or more LEDs to control a color temperature of the illumination light.

6. The lighting device of claim 2, wherein the controller is configured to control the current flows through the first, the second, the third, the fourth, the fifth, the sixth, the seventh, the eighth, and the ninth one or more LEDs based on a correlated color temperature setting input and information stored in a lookup table in relation to multiple correlated color temperature values.

7. The lighting device of claim 6, wherein the information indicates a distribution of the current among the first, the second, the third, the fourth, the fifth, the sixth, the seventh, the eighth, and the ninth one or more LEDs.

8. A lighting device, comprising:
a light source that emits an illumination light, wherein the light source comprises:
first one or more of LEDs to emit a first light having a first wavelength in a first range of 545 nanometer (nm)-555 nm;
second one or more of LEDs to emit a second light having a second wavelength in a second range of 600 nm-610 nm;
third one or more of LEDs to emit a third light having a third wavelength in a third range of 645 nm-655 nm; and
fourth one or more of LEDs to emit a fourth light having a fourth wavelength in a fourth range of 660 nm-670 nm, wherein the illumination light includes at least the first light, the second light, the third light, and the fourth light; and
a controller configured to control a current provided to the light source.

9. The lighting device of claim 8, wherein the light source further comprises:
fifth one or more of LEDs to emit a fifth light having a fifth wavelength in a fifth range of 400 nm-430 nm;
sixth one or more of LEDs to emit a sixth light having a sixth wavelength in a sixth range of 440 nm-450 nm;
seventh one or more of LEDs to emit a seventh light having a seventh wavelength in a seventh range of 470 nm-480 nm;
eighth one or more of LEDs to emit an eighth light having an eighth wavelength in an eighth range of 495 nm-505 nm; and
ninth one or more of LEDs to emit a ninth light having a ninth wavelength in a ninth range of 565 nm-575 nm, wherein the illumination light further includes the fifth light, sixth light, the seventh light, the eighth light, and the ninth light.

10. The lighting device of claim 9, wherein the first light, the second light, and the third light are each a phosphor converted light.

11. The lighting device of claim 9, wherein the controller is configured to control the current based on a correlated color temperature setting input corresponding to a desired correlated color temperature of the illumination light.

12. The lighting device of claim 9, wherein the controller is configured to control a distribution of the current to the first, the second, the third, the fourth, the fifth, the sixth, the seventh, the eighth, and the ninth one or more LEDs to control a color temperature of the illumination light.

13. The lighting device of claim 9, wherein the controller is configured to control the current flows through the first, the second, the third, the fourth, the fifth, the sixth, the seventh, the eighth, and the ninth one or more LEDs based on a correlated color temperature setting user input and information stored in a lookup table in relation to multiple correlated color temperature values.

14. The lighting device of claim 13, wherein the information indicates a distribution of the current among the first, the second, the third, the fourth, the fifth, the sixth, the seventh, the eighth, and the ninth one or more LEDs.

15. A lighting device, comprising:
a light source that emits an illumination light, wherein the light source comprises:
a first group of light emitting diodes (LEDs) to emit a warm white light;
a second group of LEDs to emit a cool white light;
a third group of LEDs to emit a deep incandescent white light having a correlated color temperature below 2000K, wherein the illumination light includes one or more of the warm white light, the cool white light and the deep incandescent white light; and
a controller configured to control a current provided to the light source, wherein each of the first group of LEDs, the second group of LEDs, and the third group of LEDs includes:
first one or more of LEDs to emit a green light;
second one or more of LEDs to emit an amber light;
third one or more of LEDs to emit a red light; and
fourth one or more of LEDs to emit a deep red light.

16. The lighting device of claim 15, wherein each of the first group of LEDs and the second group of LEDs further includes:
fifth one or more of LEDs to emit a violet light;
sixth one or more of LEDs to emit a royal blue light;
seventh one or more of LEDs to emit a blue light;
eighth one or more of LEDs to emit a cyan light; and
ninth one or more of LEDs to emit a yellow light

17. The lighting device of claim 15, wherein the green light is a phosphor converted green light, wherein the amber light is a phosphor converted amber light, and wherein the red light is a phosphor converted red light.

18. The lighting device of claim 15, wherein the controller is configured to control the current based on a correlated color temperature setting input corresponding to a desired correlated color temperature of the illumination light.

19. The lighting device of claim 15, wherein the controller is configured to control a distribution of the current among the first group of LEDs, the second group of LEDs, and the third group of LEDs to control a color temperature of the illumination light.

20. The lighting device of claim 15, wherein the controller is configured to turn off a current flow through one or more of the first group of LEDs, the second group of LEDs, and the third group of LEDs.
